(19) United States
(12) Patent Application Publication
(10) Pub. No.: US 2019/0184612 A1
(43) Pub. Date: Jun. 20, 2019

(54) USE OF A THERMOPLASTIC POLYESTER FOR PRODUCING INJECTED PARTS

(71) Applicant: ROQUETTE FRERES, Lestrem (FR)

(72) Inventors: Hélène AMEDRO, BETHUNE (FR); René SAINT-LOUP, LOMME (FR)

(21) Appl. No.: 16/322,575

(22) PCT Filed: Aug. 3, 2017
(86) PCT No.: PCT/FR2017/052181

§ 371 Date: Feb. 1, 2019

(30) Foreign Application Priority Data
Aug. 5, 2016 (FR) 1657615

(51) Int. Cl. B29C 45/00; C08G 63/199; C08G 63/672

(52) U.S. Cl. CPC B29C 45/0001; B29K 2067/00; C08G 63/672; C08G 63/199

(57) ABSTRACT

Use of a thermoplastic polyester for producing injected parts, said polyester having at least one 1,4:3,6-dianhydrohexit ol unit (A), at least one alicyclic diol unit (B) other than the 1,4:3,6-dianhydrohexitol units (A), and at least one terephthalic acid unit (C), wherein the molar ratio (A)/[(A)+(B)] is at least 0.05 and at most 0.75, said polyester being free of non-cyclic aliphatic diol units or comprising a molar amount of non-cyclic aliphatic diol units, relative to the totality of monomeric units in the polyester, of less than 5%, and with a reduced viscosity in solution (25° C.; phenol (50 wt. %): ortho-dichlorobenzene (50 wt. %); 5 g/L of polyester) greater than 50 mL/g.

### FIELD OF THE INVENTION

The present invention relates to the field of plastic objects and relates in particular to the use of a thermoplastic polyester for producing injection-molded parts, said thermoplastic polyester having properties that are particularly advantageous for this application.

### TECHNOLOGICAL BACKGROUND OF THE INVENTION

Plastics have become inescapable in the mass production of objects. Indeed, their thermoplastic character enables these materials to be transformed at a high rate into all kinds of objects.

Certain thermoplastic aromatic polyesters have thermal properties which allow them to be used directly for the manufacture of materials. They comprise aliphatic diol and aromatic diacid units. Among these aromatic polyesters, mention may be made of polyethylene terephthalate (PET), which is a polyester comprising ethylene glycol and terephthalic acid units, used for example in the production of films.

However, for certain applications or under certain usage conditions, it is necessary to improve certain properties, especially impact strength or else heat resistance. This is why glycol-modified PETs (PETgs) have been developed. They are generally polyesters comprising, in addition to the ethylene glycol and terephthalic acid units, cyclohexanedimethanol (CHDM) units. The introduction of this diol into the PET enables it to adapt the properties to the intended application, for example to improve its impact strength or its optical properties.

Other modified PETs have also been developed by introducing, into the polyester, 1,4:3,6-dianhydrohexitol units, especially isosorbide (PEITs). These modified polyesters have higher glass transition temperatures than the unmodified PETs or PETgs comprising CHDM. In addition, 1,4:3,6-dianhydrohexitols have the advantage of being able to be obtained from renewable resources such as starch.

One problem with these PEITs is that they may have inadequate impact strength properties. In addition, the glass transition temperature may be inadequate for the production of certain plastic objects.

In order to improve the impact strength properties of the polyesters, it is known from the prior art to use polyesters in which the crystallinity has been reduced. As regards isosorbide-based polyesters, mention may be made of application U.S. 2012/0177854, which describes polyesters comprising terephthalic acid units and diol units comprising from 1 to 60 mol % of isosorbide and from 5 to 99% of 1,4-cyclohexanedimethanol which have improved impact strength properties. As indicated in the introductory section of this application, the aim is to obtain polymers in which the crystallinity is eliminated by the addition of comonomers, and hence in this case by the addition of 1,4-cyclohexanedimethanol. In the examples section, the production of various poly(ethylene-co-1,4-cyclohexanedimethylene-co-isosorbide)terephthalates (PECITs), and also an example of poly(1,4-cyclohexanedimethylene-co-(PCIT), are described.

It may also be noted that while polymers of PECIT type have been the subject of commercial developments, this is not the case for PCITs. Indeed, their production was hitherto considered to be complex, since isosorbide has low reactivity as a secondary diol. Yoon et al. (Synthesis and Characteristics of a Biobased High-Tg Terpolyester of Isosorbide, Ethylene Glycol, and 1,4-Cyclohexane Dimethanol: Effect of Ethylene Glycol as a Chain Linker on Polymerization, Macromolecules, 2013, 46, 7219-7231) thus showed that the synthesis of PCIT is much more difficult to achieve than that of PECIT. This paper describes the study of the influence of the ethylene glycol content on the PECIT production kinetics.

In Yoon et al., an amorphous PCIT (which comprises approximately 29% isosorbide and 71% CHDM, relative to the sum of the diols) is produced to compare its synthesis and its properties with those of PECIT-type polymers. The use of high temperatures during the synthesis induces thermal degradation of the polymer formed if reference is made to the first paragraph of the Synthesis section on page 7222, this degradation especially being linked to the presence of aliphatic cyclic diols such as isosorbide.

Therefore, Yoon et al. used a process in which the polycondensation temperature is limited to 270° C. Yoon et al. observed that, even increasing the polymerization time, the process also does not make it possible to obtain a polyester having a sufficient viscosity. Thus, without addition of ethylene glycol, the viscosity of the polyester remains limited, despite the use of prolonged synthesis times.

Thus, despite the modifications made to the PETs, there is still a constant need for novel polyesters having improved properties.

In the plastics field and in particular for the production of injection-molded parts, it is necessary to have available thermoplastic polyesters which make it possible to obtain injection-molded parts with improved thermal and mechanical properties.

Thus, there is still at the current time the need to have available thermoplastic polyesters for producing injection-molded parts, said polyesters making it possible to obtain injection-molded parts which have improved mechanical properties and increased thermal properties.

It is thus to the applicant's credit to have found that this object could, against all is expectations, be achieved with a novel thermoplastic polyester based on isosorbide and not having ethylene glycol, while it was hitherto known that the latter was essential for the incorporation of said isosorbide. Indeed, by virtue of a particular viscosity and ratio of units, the thermoplastic polyester used according to the present invention has improved properties for use according to the invention in the production of injection-molded parts, thus broadening the fields of application of said injection-molded parts.

### SUMMARY OF THE INVENTION

Thus, a subject of the invention is the use of a thermoplastic polyester for producing injection-molded parts, said polyester comprising:
at least one 1,4:3,6-dianhydrohexitol unit (A);
at least one alicyclic diol unit (B) other than the 1,4:3,6-dianhydrohexitol units (A);
at least one terephthalic acid unit (C);
wherein the (A)/[(A)+(B)] ratio is at least 0.05 and at most 0.75; said polyester not containing any aliphatic non-cyclic diol units or comprising a molar amount of aliphatic non-cyclic diol units, relative to all the monomer units of the polyester, of less than 5%, and the reduced solution viscosity (25° C.; phenol (50% m):ortho-dichlorobenzene (50% m); 5 g/l of polyester) of said polyester being greater than 50 ml/g.

A second subject of the invention relates to a process for producing injection-molded parts from the thermoplastic polyester described above.

Finally, a third subject relates to an injection-molded part comprising the thermoplastic polyester previously described.

### DETAILED DESCRIPTION OF THE INVENTION

A first subject of the invention thus relates to the use of a thermoplastic polyester for producing injection-molded parts, said polyester comprising:
at least one 1,4:3,6-dianhydrohexitol unit (A);
at least one alicyclic diol unit (B) other than the 1,4:3,6-dianhydrohexitol units (A);
at least one terephthalic acid unit (C);
   wherein the (A)/[(A)+(B)] molar ratio is at least 0.05 and at most 0.75 and the reduced solution viscosity is greater than 50 ml/g.

“(A)/[(A)+(B)] molar ratio” is intended to mean the molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A).

The thermoplastic polyester does not contain any aliphatic non-cyclic diol units, or comprises a small amount thereof.

“Small molar amount of aliphatic non-cyclic diol units” is intended to mean, especially, a molar amount of aliphatic non-cyclic diol units of less than 5%. According to the invention, this molar amount represents the ratio of the sum of the aliphatic non-cyclic diol units, these units possibly being identical or different, relative to all the monomer units of the polyester.

An aliphatic non-cyclic diol may be a linear or branched aliphatic non-cyclic diol. It may also be a saturated or unsaturated aliphatic non-cyclic diol. Aside from ethylene glycol, the saturated linear aliphatic non-cyclic diol may for example be 1,3-propanediol, 1,4-butanediol, 1,5-pentanediol, 1,6-hexanediol, 1,8-octanediol and/or 1,10-decanediol. As examples of saturated branched aliphatic non-cyclic diol, mention may be made of 2-methyl-1,3-propanediol, 2,2,4-trimethyl-1,3-pentanediol, 2-ethyl-2-butyl-1,3-propanediol, propylene glycol and/or neopentyl glycol. As an example of an unsaturated aliphatic diol, mention may be made, for example, of cis-2-butene-1,4-diol.

This molar amount of aliphatic non-cyclic diol unit is advantageously less than 1%. Preferably, the polyester does not contain any aliphatic non-cyclic diol units and more preferentially it does not contain any ethylene glycol.

Despite the low amount of aliphatic non-cyclic diol, and hence of ethylene glycol, used for the synthesis, a thermoplastic polyester is surprisingly obtained which has a high reduced solution viscosity and in which the isosorbide is particularly well incorporated. Without being bound by any one theory, this would be explained by the fact that the reaction kinetics of ethylene glycol are much faster than those of 1,4:3,6-dianhydrohexitol, which greatly limits the integration of the latter into the polyester. The polyesters resulting therefrom thus have a low degree of integration of 1,4:3,6-dianhydrohexitol and consequently a relatively low glass transition temperature.

The monomer (A) is a 1,4:3,6-dianhydrohexitol and may be isosorbide, isomannide, isoidide, or a mixture thereof. Preferably, the 1,4:3,6-dianhydrohexitol (A) is isosorbide. Isosorbide, isomannide and isoidide may be obtained, respectively, by dehydration of sorbitol, of mannitol and of iditol. As regards isosorbide, it is sold by the applicant under the brand name Polysorb® P.

The alicyclic diol (B) is also referred to as aliphatic and cyclic diol. It is a diol which may especially be chosen from 1,4-cyclohexanedimethanol, 1,2-cyclohexanedimethanol, 1,3-cyclohexanedimethanol or a mixture of these diols. The alicyclic diol (B) is very preferentially 1,4-cyclohexanedimethanol. The alicyclic diol (B) may be in the cis configuration, in the trans configuration, or may be a mixture of diols in the cis and trans configurations.

The molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A), i.e. (A)/[(A)+(B)], is at least 0.05 and at most 0.75. When the (A)/[(A)+(B)] molar ratio is less than 0.30, the thermoplastic polyester is semicrystalline and is characterized by the presence of a crystalline phase which results in the presence of X-ray diffraction lines and the presence of an endothermic melting peak in differential scanning calorimetry (DSC) analysis.

On the other hand, when the (A)/[(A)+(B)] molar ratio is greater than 0.30, the thermoplastic polyester is amorphous and is characterized by an absence of X-ray diffraction lines and by an absence of an endothermic melting peak in differential scanning calorimetry (DSC) analysis.

A thermoplastic polyester that is particularly suitable for the production of injection-molded parts comprises:
a molar amount of 1,4:3,6-dianhydrohexitol units (A) ranging from 2.5 to 54 mol %;
a molar amount of alicyclic diol units (B) other than the 1,4:3,6-dianhydrohexitol units (A) ranging from 5 to 42.5 mol %;
a molar amount of terephthalic acid units (C) ranging from 45 to 55 mol %.

Depending on the applications and on the desired properties regarding the injection-molded part, the thermoplastic polyester may be a semicrystalline thermoplastic polyester or an amorphous thermoplastic polyester.

For example, if, for some applications, it is sought to obtain an injection-molded part that can be opaque and that has improved mechanical properties, the thermoplastic polyester may be semicrystalline and thus comprises:
a molar amount of 1,4:3,6-dianhydrohexitol units (A) ranging from 2.5 to 14 mol %;
a molar amount of alicyclic diol units (B) other than the 1,4:3,6-dianhydrohexitol units (A) ranging from 31 to 42.5 mol %;
a molar amount of terephthalic acid units (C) ranging from 45 to 55 mol %.

Advantageously, when the thermoplastic polyester is semicrystalline, it has an (A)/[(A)+(B)] molar ratio of 0.10 to 0.25.

Conversely, when it is desired for the injection-molded part to be transparent, the thermoplastic polyester may be amorphous and thus comprises:
a molar amount of 1,4:3,6-dianhydrohexitol units (A) ranging from 16 to 54 mol %;
a molar amount of alicyclic diol units (B) other than the 1,4:3,6-dianhydrohexitol units (A) ranging from 5 to 30 mol %;
a molar amount of terephthalic acid units (C) ranging from 45 to 55 mol %.

Advantageously, when the thermoplastic polyester is amorphous, it has an (A)/[(A)+(B)] molar ratio of 0.35 to 0.65.

Those skilled in the art can readily find the analysis conditions for determining the amounts of each of the units of the thermoplastic polyester. For example, from an NMR spectrum of a poly(1,4-cyclohexanedimethylene-co-isosorbide terephthalate), the chemical shifts relating to the 1,4-cyclohexanedimethanol are between 0.9 and 2.4 ppm and 4.0 and 4.5 ppm, the chemical shifts relating to the terephthalate ring are between 7.8 and 8.4 ppm and the chemical shifts relating to the isosorbide are between 4.1 and 5.8 ppm. The integration of each signal makes it possible to determine the amount of each unit of the polyester.

The thermoplastic polyesters have a glass transition temperature ranging from 85 to 200° C., for example from 90 to 115° C. if they are semicrystalline, and for example from 116° C. to 200° C. if they are amorphous.

The glass transition temperatures and melting points are measured by conventional methods, especially using differential scanning calorimetry (DSC) using a heating rate of 10° C./min. The experimental protocol is described in detail in the examples section below.

The thermoplastic polyesters used according to the invention, when they are semicrystalline, have a melting point ranging from 210 to 295° C., for example from 240 to 285° C.

Advantageously, when the thermoplastic polyester is semicrystalline, it has a heat of fusion of greater than 10 J/g, preferably greater than 20 J/g, the measurement of this heat of fusion consisting in subjecting a sample of this polyester to a heat treatment at 170° C. for 16 hours, then in evaluating the heat of fusion by DSC by heating the sample at 10° C./min.

The thermoplastic polyester used according to the invention in particular has a lightness L* greater than 40. Advantageously, the lightness L* is greater than 55, preferably greater than 60, most preferentially greater than 65, for example greater than 70. The parameter L* may be determined using a spectrophotometer, via the CIE Lab model.

Finally, the reduced solution viscosity of said thermoplastic polyester used according to the invention is greater than 50 ml/g and preferably less than 150 ml/g, this viscosity being able to be measured using an Ubbelohde capillary viscometer at 25° C. in an equi-mass mixture of phenol and ortho-dichlorobenzene after dissolving the polymer at 130° C. with stirring, the concentration of polymer introduced being 5 g/l.

This test for measuring reduced solution viscosity is, due to the choice of solvents and the concentration of the polymers used, perfectly suited to determining the viscosity of the viscous polymer prepared according to the process described below.

The semicrystalline or amorphous nature of the thermoplastic polyesters used according to the present invention is characterized, after a heat treatment of 16 h at 170° C., by the presence or absence of X-ray diffraction lines or of an endothermic melting peak in differential scanning calorimetry (DSC) analysis. Thus, when X-ray diffraction lines are present and an endothermic melting peak is present in differential scanning calorimetry (DSC) analysis, the thermoplastic polyester is semicrystalline, and if they are absent, it is amorphous.

The thermoplastic polyester according to the invention is thus used for producing injection-molded parts.

The production of the injection-molded parts may be carried out in the melt state after polymerization of the thermoplastic polyester or, according to an alternative, the thermoplastic polyester may be packaged in a form that is easy to handle, such as pellets or granules, before being used for the production of injection-molded parts. Preferentially, the thermoplastic polyester is packaged in the form of granules, said granules being advantageously dried before production of the injection-molded parts.

The drying is carried out so as to obtain granules having a residual moisture content of less than 300 ppm, preferentially less than 250 ppm.

The production of the injection-molded parts can be carried out according to techniques known to those skilled in the art. For example, the production can be carried out by injection molding, two-shot injection molding, overmolding, injection-compression molding or else by injection molding by in-mold assembly (IMA). The production is preferably carried out by injection molding.

Injection molding is a technique for forming thermoplastic material which is generally broken down into four major steps. The first step of injection molding is a plasticizing phase which makes it possible in particular to heat, to homogenize and to convey the plastic. This is then followed by a phase of actual injection molding of the plastic in a closed mold, said injection molding being followed by a cooling step and, finally, by a step of ejecting the injection-molded part thus produced.

According to one particular embodiment, one or more additional polymers may be used as a mixture with the thermoplastic polyester for producing injection-molded parts.

When an additional polymer is used, the latter may for example be added at the time of the production of the injection-molded part, for example by two-shot injection molding, or at the time of the preparation of the thermoplastic polyester.

The additional polymer may be chosen from polyamides, photoresins, photopolymers, polyesters other than the polyester according to the invention, polystyrene, styrene copolymers, styrene-acrylonitrile copolymers, styrene-acrylonitrile-butadiene copolymers, poly(methyl methacrylate)s, acrylic copolymers, poly(ether-imide)s, poly(phenylene oxide)s such as poly(2,6-dimethylphenylene oxide), poly(phenylene sulfate)s, poly(ester-carbonate)s, polycarbonates, polysulfones, polysulfone ethers, polyether ketones, and blends of these polymers.

The additional polymer may also be a polymer which makes it possible to improve the impact properties of the polyester, especially functional polyolefins such as functionalized ethylene or propylene polymers and copolymers, core-shell copolymers or block copolymers.

One or more additives may also be added to the thermoplastic polyester during the production of the injection-molded part in order to confer thereon particular properties.

Thus, by way of examples of additives, mention may be made of antioxidants, nanometric or non-nanometric, functionalized or non-functionalized fillers or fibers of organic or mineral nature. They may be silicas, zeolites, glass beads or fibers, clays, mica, titanates, silicates, graphite, calcium carbonate, carbon nanotubes, wood fibers, carbon fibers, polymer fibers, proteins, cellulose-based fibers, lignocellulosic fibers and non-destructured granular starch. These fillers or fibers can make it possible to improve the hardness, the rigidity or the surface appearance of the injection-molded parts.

The additive may also be chosen from opacifiers, dyes and pigments. They may be chosen from cobalt acetate and the following compounds: HS-325 Sandoplast® Red BB (which is a compound bearing an azo function, also known under the name Solvent Red 195), HS-510 Sandoplast® Blue 2B which is an anthraquinone, Polysynthren® Blue R, and Clariant® RSB Violet.

The additive may also be a UV-resistance agent such as, for example, molecules of benzophenone or benzotriazole type, such as the Tinuvin™ range from BASF: tinuvin 326, tinuvin P or tinuvin 234, for example, or hindered amines such as the Chimassorb™ range from BASF: Chimassorb 2020, Chimassorb 81 or Chimassorb 944, for example.

The additive may also be a fire-proofing agent or flame retardant, such as, for example, halogenated derivatives or non-halogenated flame retardants (for example phosphorus-based derivatives such as Exolit® OP) or such as the range of melamine cyanurates (for example melapur™: melapur 200), or else aluminum or magnesium is hydroxides.

Finally, the additive may also be a demolding agent or else a scratch-resistance agent, such as derivatives of hydrophobic molecules, for example Incroslip™ or Incromol™ from Croda.

The thermoplastic polyester as defined above has many advantages for the production of injection-molded parts.

Indeed, by virtue in particular of the molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A) of at least 0.05 and of a reduced solution viscosity of greater than 50 ml/g and preferably less than 150 ml/g, the thermoplastic polyesters make it possible to obtain injection-molded parts with improved thermal and mechanical properties.

More particularly, the injection-molded parts produced from a thermoplastic polyester according to the present invention have an improved glass transition temperature and/or an improved impact strength, which thus makes it possible to broaden fields of use of said injection-molded parts while at the same time providing quality products.

The injection-molded parts produced from the thermoplastic polyester according to the invention can thus be used in varied fields of application and can thus have a multitude of aspects that will depend on the final use of said part. Examples of injection-molded parts are in particular children's items such as toys, parts for small household appliances such as refrigerator compartments, kitchen items or else food containers.

A second subject of the invention relates to a process for producing an injection-molded part, said process comprising the following steps of:
a) provision of a thermoplastic polyester as defined above,
b) preparation of said injection-molded part from the thermoplastic polyester obtained in the preceding step.

The preparation step can be carried out by the methods known to those skilled in the art for producing injection-molded parts. For example, the preparation step can be carried out by injection molding, two-shot injection molding, overmolding, injection-compression molding or else by injection molding by in-mold assembly (IMA). The preparation is preferably carried out by injection molding.

A third subject of the invention relates to an injection-molded part produced from the thermoplastic polyester described previously. The injection-molded part may also comprise one or more additional polymers and also one or more additives.

The thermoplastic polyester that is particularly suitable for obtaining an injection-molded part can be prepared by means of a synthesis process comprising:
a step of introducing, into a reactor, monomers comprising at least one 1,4:3,6-dianhydrohexitol (A), at least one alicyclic diol (B) other than the 1,4:3,6-dianhydrohexitols (A) and at least one terephthalic acid (C), the molar ratio ((A)+(B))/(C) ranging from 1.05 to 1.5, said monomers not containing any aliphatic non-cyclic diols or comprising, relative to all of the monomers introduced, a molar amount of aliphatic non-cyclic diol units of less than 5%;
a step of introducing, into the reactor, a catalytic system;
a step of polymerizing said monomers to form the polyester, said step consisting of:
a first stage of oligomerization, during which the reaction medium is stirred under an inert atmosphere at a temperature ranging from 265 to 280° C., advantageously from 270 to 280° C., for example 275° C.;
a second stage of condensation of the oligomers, during which the oligomers formed are stirred under vacuum, at a temperature ranging from 278 to 300° C. so as to form the polyester, advantageously from 280 to 290° C., for example 285° C.;
a step of recovering the thermoplastic polyester.

This first stage of the process is carried out in an inert atmosphere, that is to say under an atmosphere of at least one inert gas. This inert gas may especially be dinitrogen.

This first stage may be carried out under a gas stream and it may also be carried out under pressure, for example at a pressure of between 1.05 and 8 bar.

Preferably, the pressure ranges from 3 to 8 bar, most preferentially from 5 to 7.5 bar, for example 6.6 bar. Under these preferred pressure conditions, the reaction of all the monomers with one another is promoted by limiting the loss of monomers during this stage.

Prior to the first stage of oligomerization, a step of deoxygenation of the monomers is preferentially carried out. It can be carried out for example once the monomers have been introduced into the reactor, by creating a vacuum then by introducing an inert gas such as nitrogen thereto. This vacuum-inert gas introduction cycle can be repeated several times, for example from 3 to 5 times. Preferably, this vacuum-nitrogen cycle is carried out at a temperature of between 60 and 80° C. so that the reagents, and especially the diols, are totally molten. This deoxygenation step has the advantage of improving the coloration properties of the polyester obtained at the end of the process.

The second stage of condensation of the oligomers is carried out under vacuum. The pressure may decrease continuously during this second stage by using pressure decrease gradients, in steps, or else using a combination of pressure decrease gradients and steps. Preferably, at the end of this second stage, the pressure is less than 10 mbar, most preferentially less than 1 mbar.

The first stage of the polymerization step preferably has a duration ranging from 20 minutes to 5 hours. Advantageously, the second stage has a duration ranging from 30 minutes to 6 hours, the beginning of this stage consisting in the moment at which the reactor is placed under vacuum, that is to say at a pressure of less than 1 bar.

The process also comprises a step of introducing a catalytic system into the reactor. This step may take place beforehand or during the polymerization step described above.

Catalytic system is intended to mean a catalyst or a mixture of catalysts, optionally dispersed or fixed on an inert support.

The catalyst is used in amounts suitable for obtaining a high-viscosity polymer in accordance with the use according to the invention for the production of injection-molded parts.

An esterification catalyst is advantageously used during the oligomerization stage. This esterification catalyst can be chosen from tin derivatives, titanium derivatives, zirconium derivatives, hafnium derivatives, zinc derivatives, manganese derivatives, calcium derivatives and strontium derivatives, organic catalysts such as para-acid (PTSA) or methanesulfonic acid (MSA), or a mixture of these catalysts. By way of example of such compounds, mention may be made of those given in application U.S. 2011282020A1 in paragraphs [0026] to [0029], and on page 5 of application WO 2013/062408 A1.

Preferably, a zinc derivative or a manganese, tin or germanium derivative is used during the first stage of transesterification.

By way of example of amounts by weight, use may be made of from 10 to 500 ppm of metal contained in the catalytic system during the oligomerization stage, relative to the amount of monomers introduced.

At the end of transesterification, the catalyst from the first step can be optionally blocked by adding phosphorous acid or phosphoric acid, or else, as in the case of tin(IV), reduced with phosphites such as triphenyl phosphite or tris(nonylphenyl) phosphites or those cited in paragraph [0034] of application U.S. 2011282020A1.

The second stage of condensation of the oligomers may optionally be carried out with the addition of a catalyst. This catalyst is advantageously chosen from tin derivatives, preferentially derivatives of tin, titanium, zirconium, germanium, antimony, bismuth, hafnium, magnesium, cerium, zinc, cobalt, iron, manganese, calcium, strontium, sodium, potassium, aluminum or lithium, or of a mixture of these catalysts. Examples of such compounds may for example be those given in patent EP 1 882 712 B1 in paragraphs [0090] to [0094].

Preferably, the catalyst is a tin, titanium, germanium, aluminum or antimony derivative.

By way of example of amounts by weight, use may be made of from 10 to 500 ppm of metal contained in the catalytic system during the stage of condensation of the oligomers, relative to the amount of monomers introduced.

Most preferentially, a catalytic system is used during the first stage and the second stage of polymerization. Said system advantageously consists of a catalyst based on tin or of a mixture of catalysts based on tin, titanium, germanium and aluminum.

By way of example, use may be made of an amount by weight of 10 to 500 ppm of metal contained in the catalytic system, relative to the amount of monomers introduced.

According to the preparation process, an antioxidant is advantageously used during the step of polymerization of the monomers. These antioxidants make it possible to reduce the coloration of the polyester obtained. The antioxidants may be primary and/or secondary antioxidants. The primary antioxidant may be a sterically hindered phenol, such as the compounds Hostanox® 0 3, Hostanox® 0 10, Hostanox® 0 16, Ultranox® 210, Ultranox® 276, Dovernox® 10, Dovernox® 76, Dovernox® 3114, Irganox® 1010 or Irganox® 1076 or a phosphonate such as Irgamod® 195. The secondary antioxidant may be trivalent phosphorus compounds such as Ultranox® 626, Doverphos® S-9228, Hostanox® P-EPQ or Irgafos 168.

It is also possible to introduce as polymerization additive into the reactor at least one compound that is capable of limiting unwanted etherification reactions, such as sodium acetate, tetramethylammonium hydroxide or tetraethylammonium hydroxide.

Finally, the process comprises a step of recovering the polyester upon completion of the polymerization step. The thermoplastic polyester thus recovered can subsequently be packaged in an easily handleable form, such as pellets or granules, before being used for the production of injection-molded parts.

According to one variant of the synthesis process, when the thermoplastic polyester is semicrystalline, a step of increasing the molar mass can be carried out after the step of recovering the thermoplastic polyester.

The step of increasing the molar mass is carried out by post-polymerization and may consist of a step of solid-state polycondensation (SSP) of the semicrystalline thermoplastic polyester or of a step of reactive extrusion of the semicrystalline thermoplastic polyester in the presence of at least one chain extender.

Thus, according to a first variant of the production process, the post-polymerization step is carried out by SSP.

SSP is generally carried out at a temperature between the glass transition temperature and the melting point of the polymer. Thus, in order to carry out the SSP, it is necessary for the polymer to be semicrystalline. Preferably the latter has a heat of fusion of greater than 10 J/g, preferably greater than 20 J/g, the measurement of this heat of fusion consisting in subjecting a sample of this polymer of lower reduced solution viscosity to a heat treatment at 170° C. for 16 hours, then in evaluating the heat of fusion by DSC by heating the sample at 10 K/min.

Advantageously, the SSP step is carried out at a temperature ranging from 190 to 280° C., preferably ranging from 200 to 250° C., this step imperatively having to be carried out at a temperature below the melting point of the semicrystalline thermoplastic polyester.

The SSP step may be carried out in an inert atmosphere, for example under nitrogen or under argon or under vacuum.

According to a second variant of the production process, the post-polymerization step is carried out by reactive extrusion of the semicrystalline thermoplastic polyester in the presence of at least one chain extender.

The chain extender is a compound comprising two functions capable of reacting, in reactive extrusion, with alcohol, carboxylic acid and/or carboxylic acid ester functions of the semicrystalline thermoplastic polyester. The chain extender may, for example, be chosen from compounds comprising two isocyanate, isocyanurate, lactam, lactone, carbonate, epoxy, oxazoline and imide functions, it being possible for said functions to be identical or different. The chain extension of the thermoplastic polyester may be carried out in any of the reactors capable of mixing a very viscous medium with stirring that is sufficiently dispersive to ensure a good interface between the molten material and the gaseous headspace of the reactor. A reactor that is particularly suitable for this treatment step is extrusion.

The reactive extrusion may be carried out in an extruder of any type, especially a single-screw extruder, a co-rotating twin-screw extruder or a counter-rotating twin-screw extruder. However, it is preferred to carry out this reactive extrusion using a co-rotating extruder.

The reactive extrusion step may be carried out by:
introducing the polymer into the extruder so as to melt said polymer;
then introducing the chain extender into the molten polymer;
then reacting the polymer with the chain extender in the extruder;
then recovering the semicrystalline thermoplastic polyester obtained in the extrusion step.

During the extrusion, the temperature inside the extruder is adjusted so as to be above the melting point of the polymer. The temperature inside the extruder may range from 150 to 320° C.

The semicrystalline thermoplastic polyester obtained after the step of increasing the molar mass is recovered and can subsequently be packaged in an easily handleable form, such as pellets or granules, before being again formed for the requirements of the production of injection-molded parts.

The invention will be understood more clearly by means of the examples and figures below, which are intended to be purely illustrative and do not in any way limit the scope of the protection.

### EXAMPLES

The properties of the polymers were studied via the following techniques: Reduced solution viscosity

The reduced solution viscosity is evaluated using an Ubbelohde capillary viscometer at 25° C. in an equi-mass mixture of phenol and ortho-dichlorobenzene after dissolving the polymer at 130° C. with stirring, the concentration of the polymer introduced being 5 g/l.

### DSC

The thermal properties of the polyesters were measured by differential scanning calorimetry (DSC): The sample is first heated under a nitrogen atmosphere in an open crucible from 10° C. to 320° C. (10° C. min⁻¹), cooled to 10° C. (10° C. min⁻¹), then heated again to 320° C. under the same conditions as the first step. The glass transition temperatures were taken at the mid-point of the second heating. Any melting points are determined on the endothermic peak (peak onset) at the first heating.

Similarly, the enthalpy of fusion (area under the curve) is determined at the first heating.

For the illustrative examples presented below, the following reagents were used:
1,4-Cyclohexanedimethanol (99% purity, mixture of cis and trans isomers)
Isosorbide (purity >99.5%) Polysorb® P from Roquette Freres
Terephthalic acid (99+% purity) from Acros
Irganox® 1010 from BASF AG
Dibutyltin oxide (98% purity) from Sigma-Aldrich

### Example 1

### Preparation of an Amorphous Thermoplastic Polyester and Use for Production of an Injection-Molded Part

### A: Polymerization

859 g (6 mol) of 1,4-cyclohexanedimethanol, 871 g (6 mol) of isosorbide, 1800 g (10.8 mol) of terephthalic acid, 1.5 g of Irganox 1010 (antioxidant) and 1.23 g of dibutyltin oxide (catalyst) are added to a 7.5 l reactor. To extract the residual oxygen from the isosorbide crystals, 4 vacuum-nitrogen cycles are carried out once the temperature of the reaction medium is between 60 and 80° C.

The reaction mixture is then heated to 275° C. (4° C./min) under 6.6 bar of pressure and with constant stirring (150 rpm). The degree of esterification is estimated from the amount of distillate collected. The pressure is then reduced to 0.7 mbar over the course of 90 minutes according to a logarithmic gradient and the temperature is brought to 285° C.

These vacuum and temperature conditions were maintained until an increase in torque of 10 Nm relative to the initial torque was obtained. Finally, a polymer rod is cast via the bottom valve of the reactor, cooled in a heat-regulated water bath at 15° C. and chopped up in the form of granules of about 15 mg.

The resin thus obtained has a reduced solution viscosity of 54.9 ml/g.

The ¹H NMR analysis of the polyester shows that the final polyester contains 44 mol % of isosorbide relative to the diols.

With regard to the thermal properties (measured at the second heating), the polyester has a glass transition temperature (Tg) of 125° C.

### B: Forming by Injection Molding

The thermoplastic polyester granules obtained in the preceding step are vacuum-dried at 110° C. in order to achieve residual moisture contents of less than 300 ppm; in this example, the water content of the granules is 210 ppm.

The granules, kept in a dry atmosphere, are introduced into the hopper of the injection-molding press. The injection molding is carried out on an Engel Victory 80 press.

The granules are injection-molded in the form of a plate 2 mm thick and the injection-molding parameters are collated in table 1 below:

TABLE 1

| Parameter | Units | Values |
|---|---|---|
| Temperature of the | ° C. | 270/265/265/260 |
| molten plastic | | |
| (nozzle/tube) | | |
| Mold temperature | ° C. | 50 |
| Injection speed | mm/s | 80 |
| Holding pressure | bar | 23 |
| Holding time | s | 15 |
| Cooling time | s | 15 |
| Cycle time | s | 40 |

The injection-molded parts thus obtained have a high Tg, which makes it possible to use them in applications where heat resistance is important.

Thus, when the thermoplastic polyesters according to the invention are amorphous, they are particularly suitable for the production of injection-molded parts.

### Example 2

### Preparation of a Semicrystalline Polyester and Use for Production of an Injection-Molded Part

### A: Polymerization

1432 g (9.9 mol) of 1,4-cyclohexanedimethanol, 484 g (3.3 mol) of isosorbide, 2000 g (12.0 mol) of terephthalic acid, 1.65 g of Irganox 1010 (antioxidant) and 1.39 g of dibutyltin oxide (catalyst) are added to a 7.5 l reactor. To extract the residual oxygen from the isosorbide crystals, 4 vacuum-nitrogen cycles are carried out once the temperature of the reaction medium is 60° C.

is The reaction mixture is then heated to 275° C. (4° C./min) under 6.6 bar of pressure and with constant stirring (150 rpm) until a degree of esterification of 87% is obtained (estimated from the mass of distillate collected). The pressure is then reduced to 0.7 mbar over the course of 90 minutes according to a logarithmic gradient and the temperature is brought to 285° C.

These vacuum and temperature conditions were maintained until an increase in torque of 12.1 Nm relative to the initial torque was obtained.

Finally, a polymer rod is cast via the bottom valve of the reactor, cooled in a heat-regulated water bath at 15° C. and chopped up in the form of granules of about 15 mg.

The resin thus obtained has a reduced solution viscosity of 80.1 ml/g.

The ¹H NMR analysis of the polyester shows that the final polyester contains 17.0 mol % of isosorbide relative to the diols.

With regard to the thermal properties, the polymer has a glass transition temperature of 96° C., a melting point of 253° C. with an enthalpy of fusion of 23.2 J/g.

The polyester is used in a solid-state post-condensation step.

For this purpose, the granules are crystallized for 2 h in an oven under vacuum at 170° C.

The solid-state post-condensation step is then carried out on 10 kg of these granules for 20 h at 210° C. under a stream of nitrogen (1500 l/h) in order to increase the molar mass. The resin after solid-state condensation has a reduced solution viscosity of 103.4 ml/g.

### B: Forming by Injection Molding

The polyester granules obtained in the preceding polymerization step are vacuum-dried at 150° C. in order to achieve residual moisture contents of less than 300 ppm; in this example, the water content of the granules is 127 ppm.

The granules, kept in a dry atmosphere, are introduced into the hopper of the injection-molding press.

The injection molding is carried out on an Engel Victory 80 press and the granules are injection molded in the form of bars 4 mm thick.

The injection-molding parameters are presented in table 2 below:

| Parameters | Units | Values |
|---|---|---|
| Temperature of the | ° C. | 285/280/280/270 |
| molten plastic | | |
| (nozzle/tube) | | |
| Mold temperature | ° C. | 50 |
| Injection speed | mm/s | 80 |
| Holding pressure | bar | 40 |
| Holding time | s | 20 |
| Cooling time | s | 15 |

The bars thus obtained have a very good impact strength, at ambient temperature and in the cold (−30° C.).

Thus, when the thermoplastic polyesters according to the invention are semicrystalline, they also prove to be particularly advantageous for the production of injection-molded parts.

1-18. (canceled)

19. An injection-molded part, comprising a thermoplastic polyester comprising:
at least one 1,4:3,6-dianhydrohexitol unit (A);
at least one alicyclic diol unit (B) other than the 1,4:3,6-dianhydrohexitol units (A); and
at least one terephthalic acid unit (C);
wherein the (A)/[(A)+(B)] ratio is at least 0.05 and at most 0.75;
said polyester not containing any aliphatic non-cyclic diol units or comprising a molar amount of aliphatic non-cyclic diol units, relative to all the monomer units of the polyester, of less than 5%, and the reduced solution viscosity (25° C.; phenol (50% m):ortho-dichlorobenzene (50% m); 5 g/l of polyester) of said polyester being greater than 50 m/g.

20. The injection-molded part according to claim 19, wherein the alicyclic diol (B) is a diol chosen from 1,4-cyclohexanedimethanol, 1,2-cyclohexanedimethanol, 1,3-cyclohexanedimethanol or a mixture of these diols, very preferentially 1,4-cyclohexanedimethanol.

21. The injection-molded part according to claim 19, wherein the 1,4:3,6-dianhydrohexitol (A) is isosorbide.

22. The injection-molded part according to claim 19, wherein the polyester does not contain any aliphatic non-cyclic diol units, or comprises a molar amount of aliphatic non-cyclic diol units, relative to all the monomer units of the polyester, of less than 1%.

23. The injection-molded part according to claim 19, wherein the (3,6-dianhydrohexitol unit (A) +alicyclic diol unit (B) other than the 1,4:3,6-dianhydrohexitol units (A))/(terephthalic acid unit (C)) molar ratio is from 1.05 to 1.5.

24. The injection-molded part according to claim 19, wherein the injection-molded part comprises one or more additional polymers and/or one or more additives.

25. A method for the production of an injection-molded part, comprising the following steps of:
a) provision of a thermoplastic polyester comprising at least one 1,4:3,6-dianhydrohexitol unit (A), at least one alicyclic diol unit (B) other than the 1,4:3,6-dianhydrohexitol units (A), at least one terephthalic acid unit (C), wherein the (A)/[(A)+(B)] ratio is at least 0.05 and at most 0.75, said polyester not containing any aliphatic non-cyclic diol units or comprising a molar amount of aliphatic non-cyclic diol units, relative to all the monomer units of the polyester, of less than 5%, and the reduced solution viscosity (25° C.; phenol (50% m):ortho-dichlorobenzene (50% m); 5 g/l of polyester) of said polyester being greater than 50 ml/g, and
b) preparation of said injection-molded part from the thermoplastic polyester obtained in the preceding step.

26. The method according to claim 25, wherein the alicyclic diol (B) is a diol chosen from 1,4-cyclohexanedimethanol, 1,2-cyclohexanedimethanol, 1,3-cyclohexanedimethanol or a mixture of these diols, very preferentially 1,4-cyclohexanedimethanol.

27. The method according to claim 25, wherein the 1,4:3,6-dianhydrohexitol (A) is isosorbide.

28. The method according to claim 25, wherein the polyester does not contain any aliphatic non-cyclic diol units, or comprises a molar amount of aliphatic non-cyclic diol units, relative to all the monomer units of the polyester, of less than 1%.

29. The method according to claim 25, wherein the (3,6-dianhydrohexitol unit (A)+alicyclic diol unit (B) other than the 1,4:3,6-dianhydrohexitol units (A))/(terephthalic acid unit (C)) molar ratio is from 1.05 to 1.5.

30. The method according to claim 25, wherein the injection-molded part comprises one or more additional polymers and/or one or more additives.
